(19) United States
(12) Patent Application Publication
(10) Pub. No.: US 2023/0290536 A1
(43) Pub. Date: Sep. 14, 2023

(54) WIRE HARNESS AND MANUFACTURING METHOD OF WIRE HARNESS

(71) Applicant: SUMITOMO WIRING SYSTEMS, LTD, Yokkaichi-shi (JP)

(72) Inventor: Yuya HIROMORI, Yokkaichi-shi (JP)

(73) Assignee: SUMITOMO WIRING SYSTEMS, LTD, Yokkaichi-shi (JP)

(21) Appl. No.: 18/172,788

(22) Filed: Feb. 22, 2023

(30) Foreign Application Priority Data
Mar. 9, 2022 (JP) 2022-036053

(51) Int. Cl. H01B 7/00; H01R 4/72

(52) U.S. Cl. CPC H01B 7/0045; H01R 4/72; H02G 15/1806

(57) ABSTRACT

A wire harness including: a plurality of electric wires; a pipe through which the plurality of electric wires are inserted; and a heat-shrinkable tube that is fixed to a longitudinal end of the pipe and covers and binds the plurality of electric wires. A manufacturing method of a wire harness including: inserting a plurality of electric wires into a heat-shrinkable tube; heating the heat-shrinkable tube to heat-shrink the heat-shrinkable tube, so as to cover and bind the plurality of electric wires with the heat-shrinkable tube; and inserting the plurality of electric wires into a pipe and fixing the heat-shrinkable tube to a longitudinal end of the pipe.

### BACKGROUND

The present disclosure relates to a wire harness and a manufacturing method of the wire harness.

A conventional wire harness includes a plurality of electric wires, a pipe that covers the outer periphery of the plurality of electric wires, and a holder that is fixed to a longitudinal end of the pipe and holds the electric wires (see, for example, JP 2017-84547A). The holder includes a tubular inner fitting portion fitted into the longitudinal end of the pipe, and a holding piece further extending from part of the inner fitting portion in the circumferential direction inside the pipe. The holder holds the electric wires, as a result of adhesive tape being wound around the holding piece together with the electric wires. That is to say, the adhesive tape binds the plurality of electric wires while allowing the holding piece to hold the electric wires. In such a wire harness, the holder holds the position of the electric wires relative to the end of the pipe, so that, for example, the electric wires are prevented from rubbing against the end of the pipe.

### SUMMARY

However, in a wire harness such as that described above, a binding member for covering and binding the plurality of electric wires is adhesive tape, and thus there has been a problem in that power for binding a plurality of electric wires is weak. Accordingly, for example, the positional relation the between the electric wires tends to twist. This makes an operation of inserting electric wires through a pipe difficult, for example.

An exemplary aspect of the disclosure provides a wire harness that can firmly bind a plurality of electric wires and hold the electric wires at an end portion of a pipe, and a manufacturing method of the wire harness.

A wire harness according to the present disclosure includes: a plurality of electric wires, a pipe through which the plurality of electric wires are inserted, and a heat-shrinkable tube that is fixed to a longitudinal end of the pipe and covers and binds the plurality of electric wires.

A manufacturing method of a wire harness according to the present disclosure includes inserting a plurality of electric wires into a heat-shrinkable tube, heating the heat-shrinkable tube to heat-shrink the heat-shrinkable tube, so as to cover and bind the plurality of electric wires, and inserting the plurality of electric wires through a pipe and fixing the heat-shrinkable tube to a longitudinal end of the pipe.

With the wire harness and the manufacturing method of the wire harness according to the present disclosure, it is possible to firmly bind a plurality of electric wires and hold the electric wires at an end portion of a pipe.

### BRIEF DESCRIPTION OF THE DRAWINGS

FIG. 1 is a schematic configuration view showing a wire harness according to an embodiment;

FIG. 2 is a partial plane view of the wire harness according to the embodiment;

FIG. 3 is a partial sectional view of the wire harness according to the embodiment;

FIG. 4 is a sectional view taken along line 4-4 in FIG. 3;

FIG. 5 is a partial sectional view of a wire harness in another example; and

FIG. 6 is a partial sectional view of a wire harness in another example.

### DETAILED DESCRIPTION OF EMBODIMENTS

### Description of Embodiments of the Present Disclosure

First, embodiments of the present disclosure will be listed and described.

1. A wire harness according to the present disclosure is a wire harness including a plurality of electric wires, a pipe through which the plurality of electric wires are inserted, and a binding member that is fixed to a longitudinal end of the pipe and covers and binds the plurality of electric wires, the binding member being a heat-shrinkable tube.

According to the above configuration, the binding member that is fixed to the longitudinal end of the pipe and covers and binds the plurality of electric wires is a heat-shrinkable tube, and thus it is possible to easily bind the plurality of electric wires in a tight manner. Therefore, for example, it is possible to keep the positional relation the between the electric wires from twisting. Thus, for example, an operation of inserting the electric wires through the pipe is facilitated.

2. Preferably, the heat-shrinkable tube is bonded to the electric wires using an adhesive.

According to the above configuration, since the heat-shrinkable tube is bonded to the electric wires using an adhesive, it is possible to further keep the positional relation the between electric wires from twisting.

3. Preferably, the adhesive fills all gaps between the heat-shrinkable tube and the electric wires.

According to the above configuration, since the adhesive fills all of the gaps between the heat-shrinkable tube and the electric wires, it is possible to further keep the positional relation the between electric wires from twisting.

4. Preferably, a press-fit portion that protrudes outward and is press-fit into the pipe is provided at a longitudinal portion of the heat-shrinkable tube.

According to the above configuration, the press-fit portion that protrudes outward and is press-fit into the pipe is provided at a longitudinal portion of the heat-shrinkable tube, and thus the heat-shrinkable tube can be easily fixed to the pipe. In addition, an integrated part that includes the electric wires is press-fit into the pipe, and thus the electric wires are less likely to move relative to each other inside the pipe. Thus, it is possible to further keep the positional relation the between electric wires from twisting.

5. Preferably, the press-fit portion is formed by adhesive tape wound around an outer periphery of the heat-shrinkable tube.

According to the above configuration, since the press-fit portion is formed by the adhesive tape wound around the outer periphery of the heat-shrinkable tube, the press-fit portion can be easily provided.

6. Preferably, the press-fit portion is formed integrally with the heat-shrinkable tube.

According to the above configuration, since the press-fit portion is formed integrally with the heat-shrinkable tube, it is possible to reduce the number of components and manufacturing manhours compared with a case where the press-fit portion is formed separately from the heat-shrinkable tube.

A manufacturing method of a wire harness according to the present disclosure includes:

7. a first process of passing a plurality of electric wires through a heat-shrinkable tube, a second process of heating the heat-shrinkable tube to heat-shrink the heat-shrinkable tube, so as to cover and bind the plurality of electric wires with the heat-shrinkable tube, and a third process of inserting the plurality of electric wires through a pipe and fixing the heat-shrinkable tube to a longitudinal end of the pipe.

According to the above method, it is possible to easily bind the plurality of electric wires in a tight manner using the heat-shrinkable tube. Thus, for example, it is possible to keep the positional relation the between electric wires from twisting. Thus, for example, an operation of inserting the electric wires through a pipe is facilitated.

8. Preferably, the heat-shrinkable tube that is used in the first process is a heat-shrinkable tube in which an adhesive is applied on an inner surface thereof, and, in the second process, the heat-shrinkable tube is heat-shrunk by being heated, so as to cover and bind the plurality of electric wires, and the adhesive fills all gaps between the heat-shrinkable tube and the electric wires.

According to the above method, since the adhesive fills all of the gaps between the heat-shrinkable tube and the electric wires, it is possible to further keep the positional relation the between electric wires from twisting.

### Details of Embodiments of the Present Disclosure

Specific examples of the wire harness according to the present disclosure will be described below, with reference to the drawings. In each drawing, part of the structure may be exaggerated or simplified for convenience of explanation. In addition, the dimensional ratio of each part may be different among the drawings. The present disclosure is not limited to these examples, but is defined by the claims and intended to include all modifications within the meaning and scope equivalent to the claims. The terms “parallel” and “orthogonal” as used herein respectively include not only being exactly parallel and exactly orthogonal but also being substantially parallel and substantially orthogonal within the range in which the functions and effects according to the embodiment are achieved. The terms “circular” and “arc-shaped” as used herein respectively include not only being exactly circular and exactly arc-shaped but also being substantially circular and substantially arc-shaped within the range in which the functions and effects according to the embodiment are achieved.

Overall Configuration of Wire Harness 10

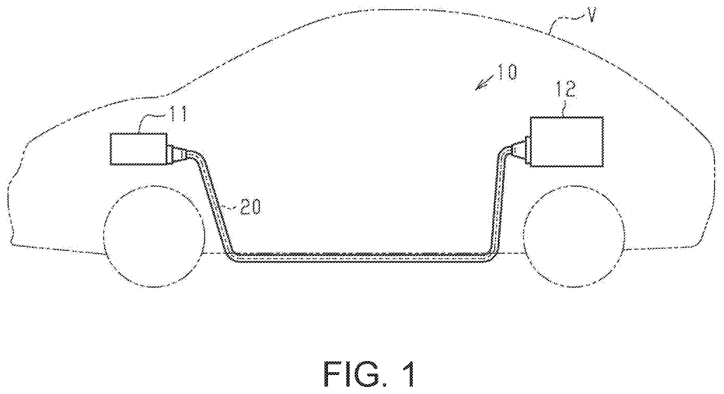

A wire harness 10 shown in FIG. 1 electrically connects two or three or more electric devices. For example, the wire harness 10 electrically connects an inverter 11 installed at the front of a vehicle V such as a hybrid vehicle or an electric vehicle and a high-voltage battery 12 installed behind the inverter 11 in the vehicle V. The wire harness 10 is, for example, routed so as to pass under the floor of the vehicle V. For example, the wire harness 10 is routed so that an intermediate portion of the wire harness in the longitudinal direction will pass outside the vehicle interior such as under the floor of the vehicle V.

The inverter 11 is connected to a motor for driving the wheels (not shown) that is a power source for vehicle travel. The inverter 11 generates AC power from DC power of the high-voltage battery 12, and supplies the AC power to the motor. The high-voltage battery 12 is, for example, a battery capable of supplying a voltage of several hundred volts.

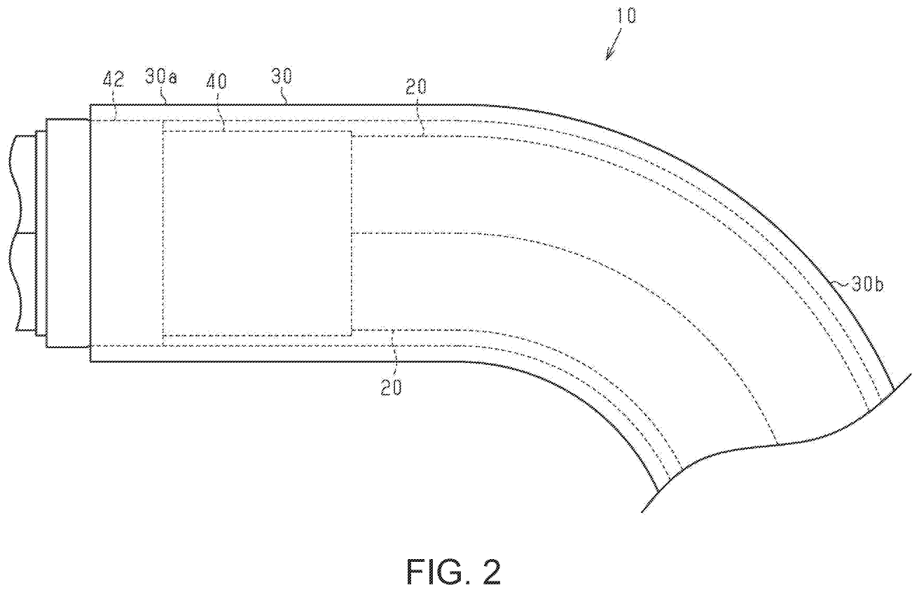

As shown in FIGS. 2 to 4, the wire harness 10 includes a plurality of electric wires that electrically connect the above electric devices, a pipe 30 that covers the outer periphery of the electric wires 20, and a heat-shrinkable tube 40 that is used as a binding member that is fixed to a longitudinal end of the pipe 30.

Configuration of Electric Wire Member 20

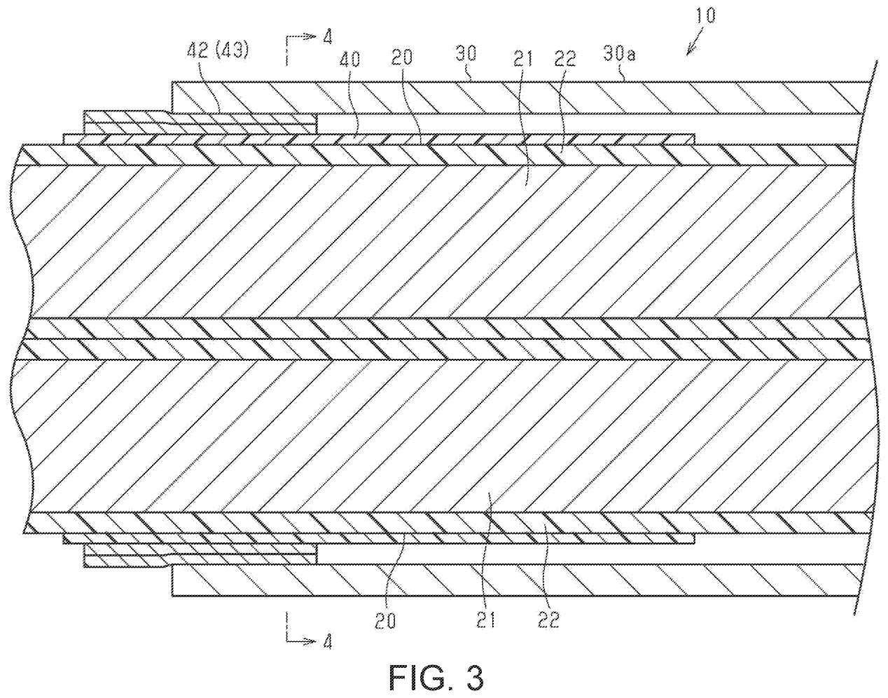

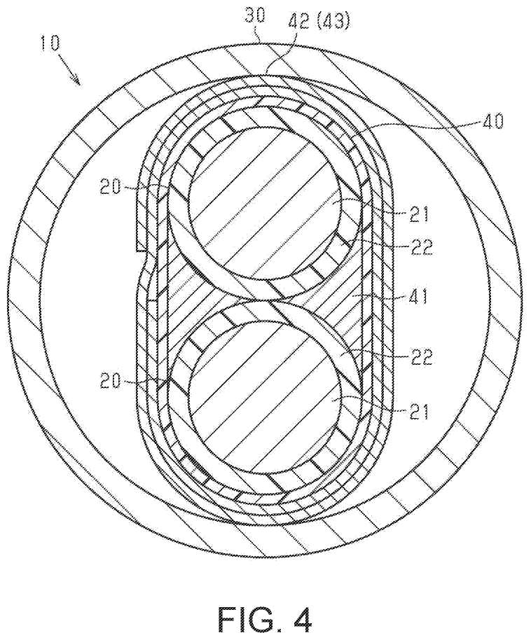

As shown in FIGS. 3 and 4, each electric wire 20 includes a core wire 21, and an insulation coating 22 that covers the outer periphery of the core wire 21. The wire harness 10 according to the present embodiment includes two electric wires 20.

As the core wire 21, for example, a stranded wire formed by twisting a plurality of metal strands or a braided member formed by braiding a plurality of metal strands into a tubular shape may be used. In this embodiment, the core wire 21 is a stranded wire. As the material of the core wire 21, for example, a metal material such as a metal material that is copper-based, aluminum-based or the like may be used. The core wire 21 which is a stranded wire is schematically shown in FIGS. 3 and 4.

The insulation coating 22 covers the entire outer peripheral surface of the core wire 21 in the circumferential direction. The insulation coating 22 is made of, for example, an insulating material such as synthetic resin.

Configuration of Pipe 30

The pipe 30 is formed in a long tube shape. In this embodiment, the pipe 30 has a perfect cylindrical shape. The pipe 30 contains, for example, an intermediate part of each electric wire 20 in the longitudinal direction. For example, the pipe 30 covers the whole outer periphery of the electric wires 20 in the circumferential direction. As the pipe 30, for example, a metal pipe or a resin pipe may be used. As the material of the metal pipe, for example, a metal material such as a metal material that is aluminum-based, copper-based, or the like may be used. As the material of the resin pipe, for example, a synthetic resin such as polyolefin, polyamide, polyester, or ABS resin may be used. In this embodiment, the pipe 30 is a metal pipe.

For example, the pipe 30 is bent two-dimensionally or three-dimensionally in parts extending upward from under the floor of the vehicle V. The pipe 30 is bent, for example, in a state of the wire harness 10 in which the electric wires 20 are inserted into the straight pipe 30. As shown in FIG. 2, the pipe 30 includes a straight portion 30a that is straight and a curved portion 30b that is curved. A portion extending from the longitudinal end of the pipe 30 to a section in a vicinity thereof is defined as the straight portion 30a.

Structure Heat-Shrinkable Tube 40

The heat-shrinkable tube 40 has heat-shrinkability for shrinking when heated. The heat-shrinkable tube 40 is configured to shrink when heated from the outside, such that the inner diameter of the heat-shrinkable tube 40 decreases. In addition, in a state before being heated, the heat-shrinkable tube 40 according to the present embodiment has a cylindrical shape through which two electric wires 20 can be passed. For this reason, the heat-shrinkable tube 40 heat-shrinks when heated in a state where the two electric wires 20 have been passed therethrough, whereby the heat-shrinkable tube 40 deforms so as to cover and bind the two electric wires 20. That is to say, the heat-shrinkable tube 40 heat-shrinks, and thereby deforms so as to bind the two electric wires 20 while bringing the electric wires into intimate contact with each other.

In addition, as shown in FIG. 4, the heat-shrinkable tube 40 is bonded to the electric wires 20 using an adhesive 41. The adhesive 41 fills all of the gaps between the heat-shrinkable tube 40 and the electric wires 20. Specifically, in a state before the electric wires 20 are passed through the heat-shrinkable tube 40, the adhesive 41 is disposed on the inner surface of the heat-shrinkable tube 40. Note that, in this state, the adhesive 41 is disposed with a uniform thickness on the inner surface of the heat-shrinkable tube 40. In addition, an amount of adhesive 41 that can fill all of the gaps between the heat-shrinkable tube 40 and the electric wires 20 when the heat-shrinkable tube 40 is heated is provided on the heat-shrinkable tube 40. The amount of adhesive 41 according to the present embodiment is set to an extent where the adhesive 41 slightly overflows from the two longitudinal ends of the heat-shrinkable tube 40 when the heat-shrinkable tube 40 is heated. When the heat-shrinkable tube 40 heat-shrinks as a result of being heated, the adhesive 41 reaches all the spaces between the heat-shrinkable tube 40 and the electric wires 20, and then cures, thereby bonding the heat-shrinkable tube 40 and the electric wires 20 to each other.

In addition, a press-fit portion 42 that protrudes outward and is press-fit into the pipe 30 is provided at the longitudinal portion of the heat-shrinkable tube 40. The press-fit portion 42 according to the present embodiment is formed by an adhesive tape 43 wound around the outer periphery of the heat-shrinkable tube 40. The press-fit portion 42 is provided by winding the adhesive tape 43 around the outer periphery of the heat-shrinkable tube 40 after the heat-shrinkable tube 40 is heated and binds the plurality of electric wires 20. Here, the adhesive tape 43 is wound around the outer periphery of the heat-shrinkable tube 40 twice. The size of the press-fit portion 42 is set such that an integrated part that includes the two electric wires 20 and the heat-shrinkable tube 40 can be press-fit into the pipe 30, by increasing the outer shape of the heat-shrinkable tube 40. That is to say, the heat-shrinkable tube 40 in a state where the two electric wires 20 are bound and before the press-fit portion 42 is provided can be passed through the pipe 30 without being press-fit into the pipe 30. Then, as a result of the press-fit portion 42 being provided, the integrated part that includes the two electric wires 20, the heat-shrinkable tube 40, and the press-fit portion 42 can be press-fit into and fixed to the pipe 30. As a result of the press-fit portion 42 being press-fit into the longitudinal end of the pipe 30, namely a section corresponding to the straight portion 30a, the two electric wires 20 and the heat-shrinkable tube 40 are fixed to the longitudinal end of the pipe 30.

Next, a manufacturing method of the wire harness 10 configured as described above will be described.

The manufacturing method of the wire harness 10 includes a first process, a second process, and a third process.

In the first process, first, two electric wires 20 are passed through the heat-shrinkable tube 40. Note that the heat-shrinkable tube 40 that is used in the first process is a heat-shrinkable tube before being heated, in other words, in a state before shrinking. In addition, the heat-shrinkable tube 40 that is used in the first process is a heat-shrinkable tube in which the adhesive 41 is disposed on the inner surface thereof.

In the second process, the heat-shrinkable tube 40 shrinks as a result of being heated, and thereby the heat-shrinkable tube 40 covers and binds the two electric wires 20. In addition, at this time, all of the gaps between the heat-shrinkable tube 40 and the electric wires 20 are filled with the adhesive 41. In other words, in the second process, the heat-shrinkable tube 40 is heated and thereby covers and binds the two electric wires 20, and the adhesive 41 moves so as to fill all of the gaps between the heat-shrinkable tube 40 and the electric wires 20. The adhesive 41 then cures as a result of being cooled.

In the third process, the two electric wires 20 are inserted through the pipe 30 and the heat-shrinkable tube 40 is fixed to the longitudinal end of the pipe 30. Note that, in the present embodiment, the press-fit portion 42 is provided by winding the adhesive tape 43 around the outer periphery of the heat-shrinkable tube 40 twice before the third process, and, in the third process, the press-fit portion 42 is press-fit into and fixed to the longitudinal end of the pipe 30.

The curved portion 30b is then formed by bending the pipe 30. In this manner, manufacturing of the wire harness 10 is completed.

The functions according to this embodiment will be described below.

The plurality of electric wires 20 are covered and bound by the heat-shrinkable tube 40 serving as a binding member. The press-fit portion 42 provided at a longitudinal portion of the heat-shrinkable tube 40 is then press-fit into the longitudinal end of the pipe 30. Accordingly, portions of the plurality of electric wires 20 in the longitudinal direction thereof are fixed to the longitudinal end of the pipe 30. In this way, for example even in the case where a force acts on the electric wires 20 when bending the pipe 30, the electric wires 20 are kept from being displaced in the longitudinal direction relative to the end of the pipe 30. Moreover, for example, the electric wires 20 are prevented from rubbing against the end of the pipe 30.

Next, the effects of this embodiment will be described below.

(1) The binding member that is fixed to the longitudinal end of the pipe 30 and covers and binds the plurality of electric wires 20 is the heat-shrinkable tube 40, and thus the plurality of electric wires 20 can be easily bound in a tight manner. Thus, for example, it is possible to keep the positional relation the between electric wires 20 from twisting. Thus, for example, an operation of inserting the electric wires 20 through the pipe 30 is facilitated.

(2) The heat-shrinkable tube 40 is bonded to the electric wires 20 using the adhesive 41, and thus it is possible to further keep the positional relation the between electric wires 20 from twisting.

(3) The adhesive 41 fills all of the gaps between the heat-shrinkable tube 40 and the electric wires 20, and thus it is possible to further keep the positional relation between the electric wires 20 from twisting.

(4) The press-fit portion 42 that protrudes outward and is press-fit into the pipe 30 is provided at a longitudinal portion of the heat-shrinkable tube 40, and thus the heat-shrinkable tube 40 can be easily fixed to the pipe 30. In addition, an integrated part that includes the electric wires 20 is press-fit into the pipe 30, and thus the electric wires 20 are less likely to move relative to each other inside the pipe 30. Thus, it is possible to further keep the positional relation between the electric wires 20 from twisting.

(5) The press-fit portion 42 is formed by the adhesive tape 43 wound around the outer periphery of the heat-shrinkable tube 40, and thus, for example, the press-fit portion 42 can be easily provided while using the heat-shrinkable tube 40 that has a simple shape with a uniform thickness.

The following modifications can be made to the foregoing embodiment. The foregoing embodiment and the modifications described below may be combined unless they are technically inconsistent.

In the above embodiment, the heat-shrinkable tube 40 is bonded to the electric wires 20 using the adhesive 41, but there is no limitation thereto, and a configuration may also be adopted in which the heat-shrinkable tube 40 is not bonded to the electric wires 20.

In the above embodiment, the adhesive 41 is disposed on the inner surface of the heat-shrinkable tube 40 in a state before the electric wires 20 are passed therethrough, but there is no limitation thereto, and, for example, the adhesive 41 may be disposed on the outer surface of the electric wires 20 in a state before the electric wires 20 are passed through the heat-shrinkable tube 40.

In the above embodiment, the adhesive 41 fills all of the gaps between the heat-shrinkable tube 40 and the electric wires 20, but there is no limitation thereto, and, for example, a configuration may also be adopted in which the adhesive 41 is disposed only in a portion of the space between the heat-shrinkable tube 40 and the electric wires 20.

In the above embodiment, the press-fit portion 42 that protrudes outward and is press-fit into the pipe 30 is provided at a longitudinal portion of the heat-shrinkable tube 40, but there is no limitation thereto, and a configuration may also be adopted in which the press-fit portion 42 is not provided. Note that, in this case, the heat-shrinkable tube 40 needs to be fixed to a longitudinal end of the pipe 30 using another structure, such as, for example, using a holder that is fixed to the longitudinal end of the pipe 30 and holds the heat-shrinkable tube 40.

In the above embodiment, the press-fit portion 42 is formed by the adhesive tape 43 wound around the outer periphery of the heat-shrinkable tube 40, but there is no limitation thereto, and the press-fit portion 42 may be changed to a press-fit portion that has a different configuration. In addition, the number of times the adhesive tape 43 is wound to form the press-fit portion 42 is not limited to two, and the adhesive tape 43 may be wound any number of times.

The press-fit portion may be formed integrally with the heat-shrinkable tube, for example.

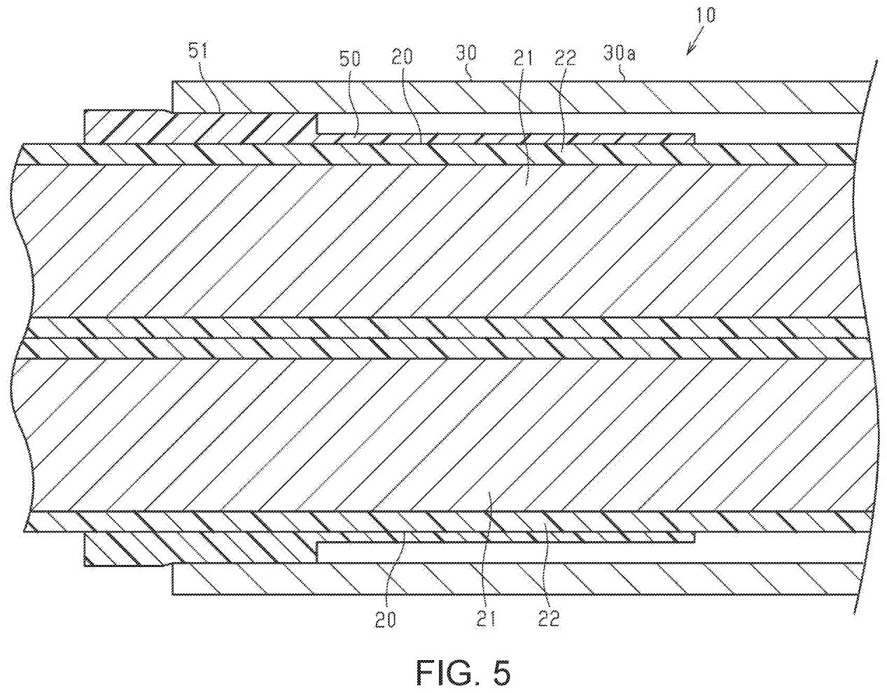

Specifically, the configuration may be changed as shown in FIG. 5, for example. A longitudinal end of a heat-shrinkable tube 50 in this example is formed to be thicker than the other portions, and forms a press-fit portion 51.

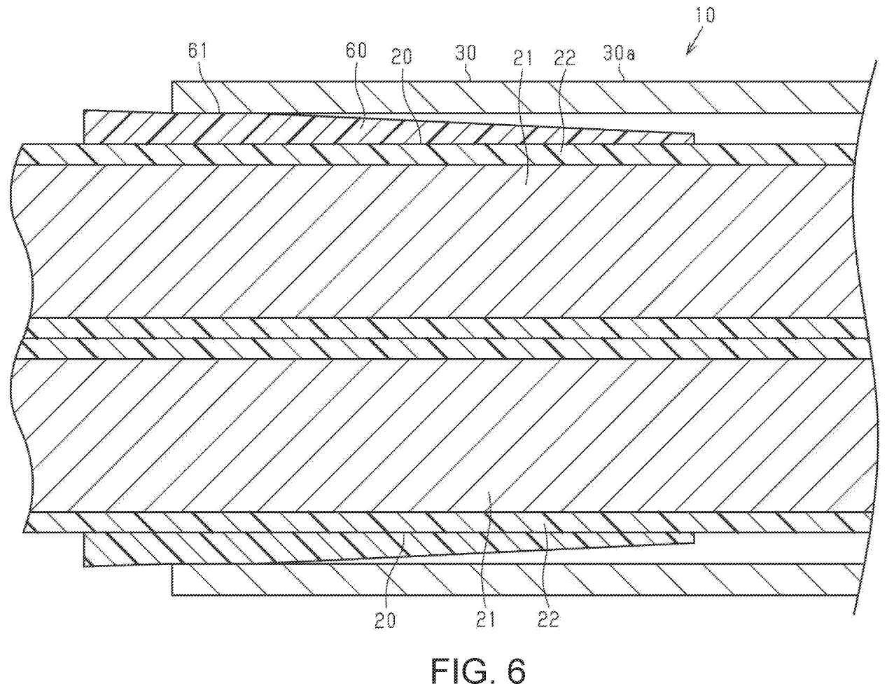

In addition, the configuration may be changed as shown in FIG. 6, for example. The thickness of a heat-shrinkable tube 60 in the longitudinal direction thereof in this example gradually increases from one end to the other, and a section that is press-fit into the longitudinal end of the pipe 30 constitutes a press-fit portion 61.

With the above configuration, it is possible to reduce the number of components of the wire harness 10 and manufacturing manhours compared with a case where the press-fit portion 42 is formed separately as in the above embodiment.

In the above embodiment, the wire harness 10 includes two electric wires 20, but there is no limitation thereto, and a configuration may also be adopted in which three or more electric wires 20 are provided. That is to say, the heat-shrinkable tube 40 may cover and bind three or more electric wires 20.

In the above embodiment, the pipe 30 is formed in a perfect cylindrical shape, but there is no limitation thereto, and, for example, the pipe 30 may be formed in a rectangular tube, an ellipsoidal shape, or the like.

In the above embodiment, the wire harness 10 electrically connects the inverter 11 and the high-voltage battery 12 to each other, but there is no limitation thereto, and the wire harness 10 may connect other electric devices.

What is claimed is:

1. A wire harness comprising:
a plurality of electric wires;
a pipe through which the plurality of electric wires are inserted; and
a heat-shrinkable tube that is fixed to a longitudinal end of the pipe and covers and binds the plurality of electric wires.

2. The wire harness according to claim 1,
wherein the heat-shrinkable tube is bonded to the plurality of electric wires using an adhesive.

3. The wire harness according to claim 2,
wherein the adhesive fills all gaps between the heat-shrinkable tube and the plurality of electric wires.

4. The wire harness according to claim 1,
wherein a press-fit portion that protrudes outward and is press-fit into the pipe is provided at a longitudinal portion of the heat-shrinkable tube.

5. The wire harness according to claim 4,
wherein the press-fit portion is formed by adhesive tape wound around an outer periphery of the heat-shrinkable tube.

6. The wire harness according to claim 4,
wherein the press-fit portion is formed integrally with the heat-shrinkable tube.

7. A manufacturing method of a wire harness, comprising:
inserting a plurality of electric wires into a heat-shrinkable tube;
heating the heat-shrinkable tube to heat-shrink the heat-shrinkable tube, so as to cover and bind the plurality of electric wires with the heat-shrinkable tube; and
inserting the plurality of electric wires into a pipe and fixing the heat-shrinkable tube to a longitudinal end of the pipe.

8. The manufacturing method of the wire harness according to claim 7, wherein:
an adhesive is applied on an inner surface of the heat-shrinkable tube, and
the heat-shrinkable tube is heat-shrunk by being heated, so as to cover and bind the plurality of electric wires, and the adhesive fills all gaps between the heat-shrinkable tube and the electric wires.
